(19) United States
(12) Patent Application Publication
(10) Pub. No.: US 2008/0073088 A1
(43) Pub. Date: Mar. 27, 2008

(54) Special application control sprinkler for use in fire protection

(76) Inventors: Stephen R. Ide, Nazareth, PA (US); William J. Reilly, Langhorne, PA (US); Robert J. Ballard, Whitehall, PA (US)

Correspondence Address: ABELMAN, FRAYNE & SCHWAB, 666 THIRD AVENUE, 10TH FLOOR, NEW YORK, NY, 10017, US

(21) Appl. No.: 11/977,628

(22) Filed: Oct. 24, 2007

Related U.S. Application Data
(63) Continuation-in-part of application No. PCT/US2007/003826, filed on Feb. 9, 2007.
(60) Provisional application No. 60/774,052, filed on Feb. 15, 2006.

(51) Int. Cl. A62C 35/00

(52) U.S. Cl. 169/37; 169/16

(57) ABSTRACT

A sprinkler having a design such that they can be arrayed where the coverage of each exceeds 80 square feet—preferably less than 200 square feet in extra hazard or high piled storage environments up to ceiling heights of 25 feet or greater, including ceiling heights of approximately 30 feet or greater and being adapted to control through the maintenance of the heat release rate for the prescribed period of time established by NFPA-13 standards for what are termed “Extra Hazard” and “High Piled Storage” occupancy in which sprinklers preferably having a K factor of 18-40 through the selective combination of pressure and trigger-speed provide sufficiently large drops of water to permit the same to maintain sufficient size and density after contacting the structural members generally encountered in warehouse-type facilities to be able to penetrate the fire plume. Specifically, in its preferred embodiment if the pressure is 7-10 psi, a diagonal line emanating from the center of the deflector to the edge of the obstruction (A) is greater than 3 times the height or 3 times the width of the obstruction.

### CROSS REFERENCE TO RELATED APPLICATIONS

This application is a Continuation-in-Part and claims the benefit of PCT application no. PCT/US2007/003826, filed Feb. 9, 2007, which claims the benefit of U.S. Provisional Patent Application No. 60/774,052, filed Feb. 15, 2006, the disclosures of both which are incorporated by reference herein in their entirety and made a part of this application.

### TECHNICAL FIELD

The present application relates to a sprinkler and sprinkler systems used in the control of fires. In the field of fire protection the term “control” has a particular meaning. “Control” relates to containment and for a particular hazard requires that for a prescribed period of time the heat release rate of the fire is maintained with prescribed limits, thus controlling the same until it naturally abates or until measures to extinguish the fire can be taken. In the field of fire protection “suppression” has a particular meaning. “Suppression” means a fire protection device configured to sharply reduce the heat release rate of a fire and prevent its regrowth by means of direct and sufficient application of fire fighting fluid through a fire plume to a burning fuel surface.

The present application relates to control mode sprinklers of the type known as “Special Sprinklers” and the manner of their array in high ceiling storage facilities such that the sprinklers can be used to control what are termed “Extra Hazard” and “High Piled Storage” occupancy (sometimes referred to herein as “high challenge fires”), preferably without the need for supplemental pumps.

### BACKGROUND

Fire protection sprinklers have been known for decades as is their manner of operation. The sprinkler, or the array of sprinklers must, given the potential challenge posed by the fire, achieve either control (i.e., containment) or suppression. However, developing a sprinkler or a sprinkler system which has practical applications and meets the various criteria established by the industry (NFPA-13) and certification agencies (e.g., Underwriter Laboratories (UL) or Factory Mutual (FM) Global Datasheets) poses significant challenges.

In its most elementary sense a sprinkler generally includes:
a generally tubular body having an inlet end and an opposing discharge end;
an internal passageway extending between the inlet and discharge ends;
a deflector coupled with a tubular body and spaced from and generally in line with the discharge end of the internal passageway so as to be impacted by the flow of water issuing from the discharge end of the passageway upon activation of the sprinkler;
a closure releasably positioned at the discharge end of the tubular body so as to close the internal passageway; and
a heat responsive trigger mounted to releasably retain the closure at the discharge end of the tubular body.

As well, there are generally a number of known types of sprinklers. The two most common are the “upright” and the “pendent” types. An upright sprinkler is operably engaged with and extends vertically above the water supply pipe or conduit. A pendent sprinkler is operably engaged with and depends below the water supply conduit. Each has various benefits.

In recent years larger sprinklers have been developed and they are fed by larger conduits. As a consequence, a larger water pipe below an upright sprinkler creates an obstacle for the water flow, often referred to as a “shadow”. As well, by having the water exit upwardly rather than downwardly, the momentum of the water is reduced. Moreover, the upright orientation often presents installation issues relating to access and clearance above the pipe. Nonetheless, because of the benefit of being able to use an umbrella-like deflector to direct water flow, often, in addition to pendant designs, upright configurations have also been designed for special purpose applications.

The size of the tubular body of a sprinkler is generally denominated by what is referred to as a “discharge coefficient” or “K factor”. Generally the larger the K factor the greater the diameter of the internal passageway of the tubular body.

The K factor equals the flow of water through the internal passageway, and is expressed hereinafter in Imperial units as gallons per minute divided by the square route of the pressure of water fed into the tubular body in pounds per square inch gauge (gpm/psi^{1/2}). However, those skilled in the art will appreciate that the K factor can be expressed in SI units as liters per minute divided by the square route of the pressure of water fed into the tubular body in newtons per square meter (L/min/kPa^{1/2}). As is well recognized in the industry, the discharge coefficient is governed in large degree by the smallest cross sectional area of the passageway—in other words, the smallest diameter of the cylindrical portion of the passageway. The discharge coefficient or K factor of a sprinkler is determined by standard flow testing.

Typically, K factors are expressed in standard sizes, which are integer or half integer values. The standard or “nominal” values encompass the stated integer or half integer value plus or minus a half integer. Thus, a nominal K factor of 25 encompasses all measured K factors between 24.5 and 25.5.

The ability of a sprinkler or system of sprinklers to perform in a given environment often varies based upon how quickly a sprinkler in an array or multiple sprinklers in an array are activated. There are variations in the speed by which the heat responsive trigger is actuated to release the closure at the discharge end of the tubular body. The industry generally refers to the response time as a “response time index” or “RTI”. This is a measure of thermal sensitivity.

Response can be measured in various ways. The two principal listing agencies for sprinklers, FM and UL, use a combination of temperature ratings and response time indices to insure adequate response is being provided.

RTI is equal to τu^{1/2} where τ is the thermal time constant of the trigger in units of seconds and u is the velocity of the gas across the trigger. RTI is determined experimentally in a wind tunnel by the following equation:
RTI=−tₓu^{1/2}/ln(1−ΔT_{b}/ΔT_{g})

where tₓ is the actual measured response or actuation time of the sprinkler; u is the gas velocity in the test section with the sprinkler; ΔT_{b} is the difference between the actuation temperature of the trigger (determined by a separate heat soak test) and the ambient temperature outside the tunnel (i.e., the initial temperature of the sprinkler); and ΔT_{g} is the difference between the gas temperature within the tunnel where the sprinkler is located and the ambient temperature outside the tunnel. There are standards established by Factory Mutual and Underwriters Laboratories to measure RTI which provide further momentum.

The manner in which sprinklers achieve the desired end result of controlling a fire has been studied by various experts and although there is no unanimity of view, it is generally well accepted that water discharged by sprinklers attacks a fire in multiple ways.

One of the ways is by cooling both at the roof where relatively small drops of the discharged water are lifted by the heat of the fire in cool gas layers to the ceiling. Sprinklers with lower K factors tend to have greater discharge pressures and thus a greater proportion of small droplets or mist is created. Thus, one of the benefits of sprinklers with smaller K factors is increasing the cooling at the ceiling level, (i.e., generally smaller orifice sprinklers).

Another way that sprinklers function is by having the discharged water, if it arrives early enough and in sufficient quantities, dampen the area beyond that which is burning and thus provide a cooling effect to assist in controlling further spread of the fire for certain prescribed periods of time. Sprinklers which direct water more radially outward tend to provide this benefit.

Lastly, there is an attribute generally referred to as “penetration”. This relates to the capability of the water discharge to reach the fire, which requires that either due to its momentum, i.e., velocity and/or droplet size, the water can penetrate the fire plume. It has long been recognized if the water pressure is the same, that large K factors provide larger droplets, but at a higher momentum.

As understood by those skilled in the art, whether penetration will occur at a desired level and in a desired pattern depends upon a number of factors including:
the velocity of the water at the time of discharge which, for the same water pressure service tends to be generally greater with lower K factors;
the intended coverage or density of the sprinkler—with a narrower dispersion concentrating the flow and thus assisting penetration;
the ceiling height—with higher placement of the sprinkler increasing the time it takes for the plume to actuate the heat responsive trigger and thus often presenting a hotter and strong plume which must be penetrated;
the speed or RTI of the trigger mechanism which releases the water;
the nature of the materials which are burning; and
the objective, i.e., control or suppression.

Control Mode Density Area (CMDA) sprinkler protection is the most commonly used sprinkler technology for the protection of storage. It was developed in the late 1960's. At that time there were rapid changes in storage technology. Rack storage was being developed and goods were being stored at greater heights in larger warehouses, with the goods being accessible by various equipment which permitted higher, yet still accessible storage. The sprinklers used then and to some degree still used today in many facilities have K factors of 5.6 and 8.0 and these sprinklers can be serviced by the customary water supply systems—which had water pressure in the general range of 50 psi delivered to the facility although pressures that high were not required.

In the 1970's a larger K factor sprinkler, in particular a K11.2 sprinkler was designed and is commonly referred to as a “Large Drop” CMSA (control mode specific application) sprinkler. The term “Large Drop” refers to the fact that the larger K factor along with the deflector design produced a higher proportion of large water drops. Although this reduced the momentum, it enhanced penetration and performance because of the larger size of the water droplets.

Those in the field recognized that particularly for what might be considered high challenge storage sprinkler, larger orifices and lower operating pressure could be employed in lieu of the smaller K factor (K5.6 and K8.0 sprinklers) where greater emphasis was on the discharge density in the operating area to be protected. Depending upon ceiling height, these large drop sprinklers were accepted for use, and in some instances, smaller K factor sprinklers mounted on the storage racks could be eliminated.

In the 1980's Factory Mutual Research developed what is referred to as the first “early Suppression Fast Response” (ESFR) sprinkler with a nominal K factor of 14. The development had two objectives. The first was to address issues of higher ceiling facilities and the other was to achieve what is referred to as “suppression.” As noted, control mode sprinklers generally permit a fire to continue to burn in the area of ignition, but control its spread until either the fire burns itself out or some additional means of fire fighting puts the fire out. Suppression mode sprinklers penetrate to stop fire growth quickly; reduce heat release and are more likely to put the fire out. The next generation of ESFR sprinklers adopted larger K factors in the 16-25 range. Although these ESFR sprinklers have been embraced by end users, one of the attributes of the fast response attribute has had unintended adverse consequences. The RTI required for the “fast response” is significantly more rapid than had been the case in the past for control mode sprinklers and has created an environment in which the activation of one ESFR sprinkler head adversely affects the performance of an adjacent sprinkler head.

To a significant degree the design parameters of the ESFR-type sprinkler having a K factor of 14 or greater—and in particular those designed to operate at low pressure, rely on the fast response of the sprinkler both to limit the number of sprinklers that activate and the size of the fire when the sprinkler activates. The environment for most of the sprinklers are warehouses with a series of racks and when a fire occurs, the fire plume rises, but not necessarily immediately above the fire. Often due to air currents and positioning of storage and the space between stored items or for other reasons, there is a variation in the heat distribution pattern of the fire. As a consequence, it is possible that sprinklers beyond the intended zone of operation are open before sprinklers located closer to the fire.

If this occurs the sprinkler system will not operate in its intended manner and its effectiveness will be greatly reduced and indeed, might result in a loss of the entire storage facility because the fire will have grown to an extent beyond the capabilities of the sprinkler system to either control or suppress it because the appropriate sprinklers were not triggered at the appropriate times.

Another problem encountered is the change in droplet size and plume penetration characteristics if a sprinkler is mounted too close to a structural member. The required spacing between ESFR sprinklers is closer than that mandated for control mode sprinklers. In such instances the fluid released through the ESFR sprinkler, typically water, encounters an obstruction such as a structural member supporting the warehouse or the storage racks, even with the lower pressure, the velocity is such that the drops fracture into significantly smaller droplets. As a result the ability of the droplets to penetrate the fire plume is seriously impaired. For that reason it was generally recommended that these sprinklers be mounted below the obstruction. However, that is not always possible in high ceiling warehouse type facilities. Therefore in many instances the sprinklers are mounted above the obstruction. In such circumstances the regulatory guidelines require that the sprinkler be spaced a minimum distance from the obstruction, measured from the center of the deflector to the obstruction or the sprinkler will not perform as intended.

However, the layout of the piping system and the placement of the sprinkler heads often do not readily permit compliance with the spacing requirements and there exists today many installations in which the sprinkler heads are too close to the obstruction. Therefore, there are many installed systems which must be retrofit to reposition the sprinkler heads if they are to perform in the manner for which they were designed.

As is recognized in the industry, performance in the specified manner for which the sprinkler is designed is critical. To be acceptable in the marketplace, sprinklers must meet certain specified industry standards and certified as meeting those standards by the recognized listing agencies.

Industry standards are established by the National Fire Protection Association (NFPA). The current standard governing minimum requirements for design and installation of automatic fire sprinkler systems is the 1999 Edition of NFPA 13 entitled “Standard for the Installation of Sprinkler Systems.”

The 1999 Edition of NFPA 13 recognizes various classes of occupancies, termed: “Light Hazard,” “Ordinary Hazard,” “Extra Hazard,” and “Special Occupancy Hazard,” as well as various types of storage commodity classes, including: “Miscellaneous Storage” and “High-Piled Storage.”

High-Piled Storage includes solid-piled, palletized, rack storage, bin box and shelf storage in excess of twelve feet in height.

NFPA-13 specifies the requirements for automatic fire sprinkler systems based upon the occupancy type and the potential fire hazard likely to be encountered.

As suggested by its name Light Hazard occupancies are those where the quantity or combustibility of contents are low and fires with relatively low rates of heat release are expected. Ordinary Hazard as its name implies, relates to occupancies where the quantity or combustibility of the contents is equal to or greater than that of Light Hazard, where the quantity of combustibles is moderate and stock piles do not exceed twelve feet, and where fires with moderate to high rates of heat release are expected.

Extra Hazard occupancies are those where quantity and combustibility of the contents are very high, such that the probability of rapidly developing fires with high rates of heat release is very high.

There are two other categories, Miscellaneous Storage and High-Piled Storage. For those situations various levels of fire protection requirements are based on the type of materials, the amount of material, the height of storage, and clearance between the top of the storage and the ceiling, as well as how the materials are stored.

NFPA-13 also specifies maximum areas of protection per sprinkler for the various hazard occupancies. For example, 225 square feet per sprinkler for a Light Hazard application with unobstructed ceiling construction; 130 per sprinkler square feet for an Ordinary Hazard application with all types of approved ceiling construction; and 100 square feet per sprinkler for Extra Hazard and High-Piled Storage applications with a water discharge density requirement equal to or greater than 0.25 gallon per minute per square foot, for any type of approved ceiling construction. The maximum area of protection per sprinkler for Miscellaneous Storage is determined by its Ordinary Hazard or Extra Hazard classification.

NFPA thus sets standards and the Listing Agencies conduct tests to see if the standards are met by a particular design for the maximum allowable spacing and minimum water discharge requirements for standard spray upright and pendent sprinklers based on fire tests suitable to the selected hazard performed on like type sprinklers.

In or about 1973, NFPA began to recognize a category sprinkler known as a “Special Sprinkler” which, for example, included sprinklers specially designed to cover greater areas (i.e., “extended coverage” sprinklers) where fire tests demonstrated them to suitably be given consideration to such factors as the hazard category, water distribution pattern, wetting of floor and walls, the likely interference of the spray pattern by structural elements and response sensitivity.

In the 1990's extended coverage type Special Sprinklers were developed and approved for Light Hazards and Ordinary Hazards and the use of Special Sprinklers in Extra Piled Storage was permitted under general guidelines which reduced maximum protection area for each sprinkler in the array. Indeed, in 1996 it was suggested as well that larger K factor sprinklers in the range of 22 K Factor and 30 K factor have the preferred characteristics for Extra Hazard and High Piled Storage occupancy, and guidelines for installation of extended coverage upright and pendent sprinklers were included in the 1996 Edition of NFPA-13.

As well, in the 1990's it was suggested that extended coverage (i.e., Special Sprinklers) should have more rapid response times, specifically that the RTI of the heat responsive trigger should be less than 100 meter^{1/2} sec^{1/2} (m^{1/2} s^{1/2}) and preferably less than 50 meter^{1/2} sec^{1/2} (m^{1/2} s^{1/2}) and larger K factors (e.g., greater than 16 should be used).

It is therefore not surprising that both with respect to early suppression sprinklers or extended coverage Special Sprinklers that K factors greater than 16 and RTI's of less than 100 meter^{1/2} sec^{1/2} were developed.

Nonetheless, despite the fact that the Special Sprinklers were intended to provide extended coverage on a per sprinkler basis, the NFPA 13 requirement of closer spacing required the sprinklers to be arrayed more densely if used for extra hazard and high piled storage facilities—i.e., within the 100 square feet per sprinkler range.

As a consequence, sprinklers with highly sensitive triggering mechanisms are arrayed more closely than was intended by their coverage design with the result that the faster RTI resulted in the potential that the wrong sprinkler is activated and the system of sprinklers not perform as intended.

Among the consequences of the closer array is the potential that the cooling effect of one sprinkler could cool the trigger of an adjacent sprinkler and would cause it to react significantly slower than its theoretical design specifications. Another adverse consequence, particularly as sprinklers are arrayed at ceiling heights of 25 feet or higher, is that the sprinkler heads are mounted above the height of structural support members and the released fluid is being deflected and modified by the obstructing support member.

Moreover, this latter problem is exacerbated by the failure of installers to provide for the minimum spatial set-off of the sprinklers from the obstructions. Therefore, despite standards and extensive and expensive testing, approved sprinkler designs are failing to perform in the manner intended by their design.

As a result, there has developed a need for larger K factor sprinklers adaptable for higher ceilings which reduces the possibility of the triggering of a sprinkler which first encounters sufficient heat to discharge fluid adversely delaying the activation of an adjacent sprinkler and, as well, a sprinkler which can be installed closer to structural members without adversely affecting the fire control capabilities of the sprinkler system.

### SUMMARY OF THE PRESENT INVENTION

According to the present invention there is disclosed a sprinkler having a design such that they can be arrayed where the coverage of each exceeds 80 square feet—preferably less than 200 square feet in extra hazard or high piled storage environments up to ceiling heights of 25 feet or greater, including ceiling heights of 35-40 feet, and even as high as 60 feet. As disclosed in applicant's earlier application, one manner of solving the aforementioned problems is to provide an array of low pressure sprinklers; with each sprinkler having a nominal K factor of 25 or greater and preferably in the range of 18-40; and each sprinkler having an RTI greater than 101 m^{1/2}s^{1/2} and which includes a deflector which creates large drops; and which meets NFPA-13 standards.

Contrary to the concept that a faster RTI is beneficial, such sprinklers employ slower RTI and thus a greater level of sensed heat required to act as a trigger is required. As a consequence, the system is intentionally designed to operate more than one sprinkler head initially and due to the lower velocities and larger coverage area, the adverse effects of obstructions in triggering the sprinklers, and the adverse effects where a lesser number of sprinkler heads is triggered because of a too early triggering of the wrong sprinkler, is significantly reduced.

It has also been found that the present invention can perform satisfactorily even at less rapid trigger speeds if the fluid pressure is reduced, such as by having more sprinkler heads activated simultaneously. The ability to deliver large droplets of water from a greater number of sprinkler heads simultaneously has the unexpected benefit of permitting the sprinkler heads to be mounted closer to the structural members. Given the reduced velocity of the fluid due to the lower pressure, when the fluid encounters the structural member it is less likely to become too small to penetrate the plume or dissipate as mist.

As well, where multiple sprinklers are actuated simultaneously, both the increased number of heads and/or the larger droplet sizes has the benefit that the “shadow” effect is less likely to have an adverse effect on the sprinklers providing appropriate coverage. Thus, the present invention therefore also contemplates the use of upright as well as pendent sprinklers.

In one embodiment, the sprinkler can be adapted for installation below a ceiling of an indoor storage area (e.g., a warehouse storage area or other storage compartment) having a structural member positioned below the ceiling. The structural member can include at least one obstructing member portion having a height and width. In one embodiment, the structural member is an open web truss or I-beam.

The sprinkler is preferably positioned laterally of and above the obstructing member portion at a radial distance greater than at least three times a largest dimensional value of either the height or width of the obstructing member. Preferably, the radial distance is measured from a center of the deflector to a closest surface point of the obstructing member portion, such that droplets of a fire extinguishing liquid dispersed from the sprinkler are sufficiently large in accordance with the requirements under NFPA-13 and FM Global Datasheets, even after encountering the obstructing member portion.

In another embodiment, an array of sprinklers of the present invention is installed below a ceiling of an indoor storage area having a structural member positioned below the ceiling. Each sprinkler is positioned laterally of and above the obstructing member portion at a radial distance greater than at least three times a largest dimensional value of either the height or width of the obstructing member, such that droplets of a fire extinguishing liquid dispersed from the sprinkler are sufficiently large in accordance with the requirements under NFPA-13, even after encountering the obstructing member portion.

Therefore, the present invention provides a system for protection in high ceiling/high challenge environments, including those with ceiling heights of preferably 30 ft. to 40 ft. or higher.

### DESCRIPTION OF DRAWINGS

FIG. 1 is a top elevation view of one embodiment of a low pressure, high challenge pendent fire protection sprinkler in accordance with the present invention with a deflector illustrated being slightly reduced in proportions;

FIG. 2 is a bottom perspective view of another embodiment of the pendent fire protection sprinkler of the present invention;

FIG. 3 is a top plan view of the deflector of FIGS. 1 and 2;

FIG. 4 is a perspective view of a deflector suitable for use with an upright sprinkler;

FIG. 5 is a schematic view of an array of sprinklers in accordance with the present invention;

FIG. 6 is a perspective view of a prior art ESFR sprinkler in its spaced required relationship to structural members; and

FIG. 7 is a side elevational, partly schematic view showing an illustrative spacing of a sprinkler of the present invention and a structural member.

### DETAILED DESCRIPTION OF THE PREFERRED EMBODIMENTS

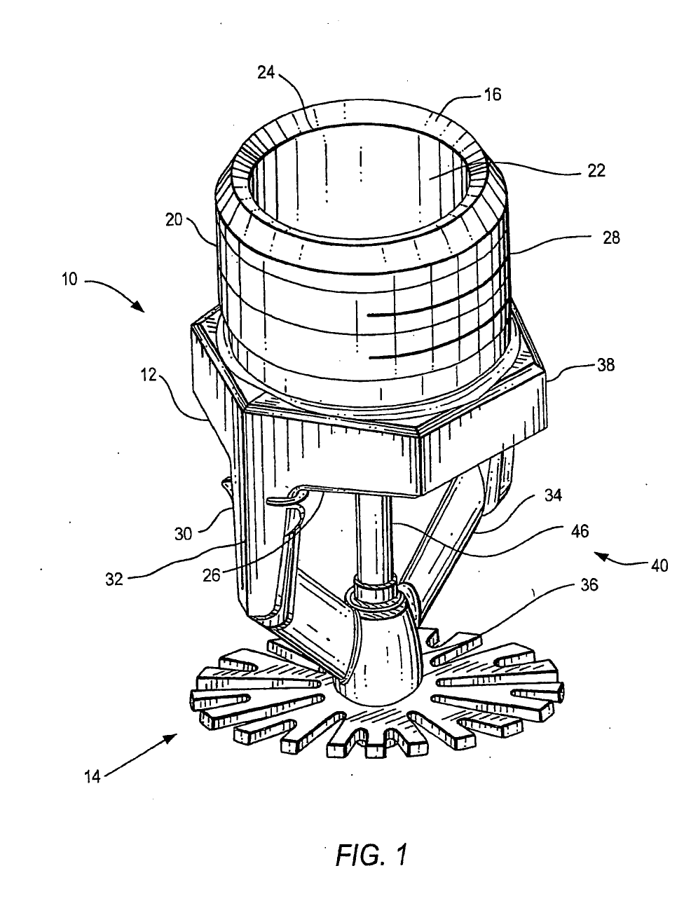

With reference to FIG. 1, a sprinkler 10 in accordance with a preferred embodiment of the present invention has two main components: a frame 12 and a deflector 14.

The frame 12 is hollow and substantially tubular at its upper portion, having an upper inlet orifice 16 for receiving a stream of fire fighting liquid (not illustrated) such as water. For convenience, the present application will refer to the liquid as water, but any appropriate flowable substance may be used.

The frame 12 further includes a lower outlet orifice (not visible) through which the stream of water may be discharged downwardly. The sprinkler 10 is of the pendent type with the deflector 14 positioned below the frame 12 to at least partially intercept the stream of water to convert the stream of water into a spray of water droplets distributed in a predetermined pattern.

The frame 12 includes a tubular body 20 defining an internal passageway 22 having the inlet orifice 16 at an upper inlet end 24. The lower discharge end of the passageway 22 in the frame 12 forms the outlet orifice. Threads 28 are provided on the outside of the inlet end 24 to permit the sprinkler 10 to be coupled to a drop or supply pipe (not illustrated) for delivery thereto of water or another fire fighting liquid. With K factors in the mid 20's to the lower to mid 40's, the pipe will likely be fed by a main with a nominal 3″ diameter and the sprinkler mounted on a pipe with a nominal 1″ diameter, thus making it less suitable for upright-type sprinklers.

As shown in FIG. 1, the frame 12 further includes a yoke 30 having opposed support arms 32, 34 which extend generally away from the discharge end 26 of the body 20 and meet to form a conical screw-boss or nose 36 along the central axis of the internal passageway. The support arms 32, 34 and the screw-boss or nose 36 support the deflector 14 positioned juxtaposed to, facing and spaced away from the discharge end of the body 20.

While two symmetrically positioned support arms are preferred, additional support arms may be provided, preferably symmetrically positioned around and spaced away from the central axis. As well, the nose 36 may be modified in shape and design to assist in the dispersion pattern of the water exiting the discharge end of the tubular body 20.

The frame 12 is preferably enlarged at the discharge end of the body 20 in a circumferential boss 38, preferably hexagonally shaped to allow easy tightening from many angles, reducing the assembly effort.

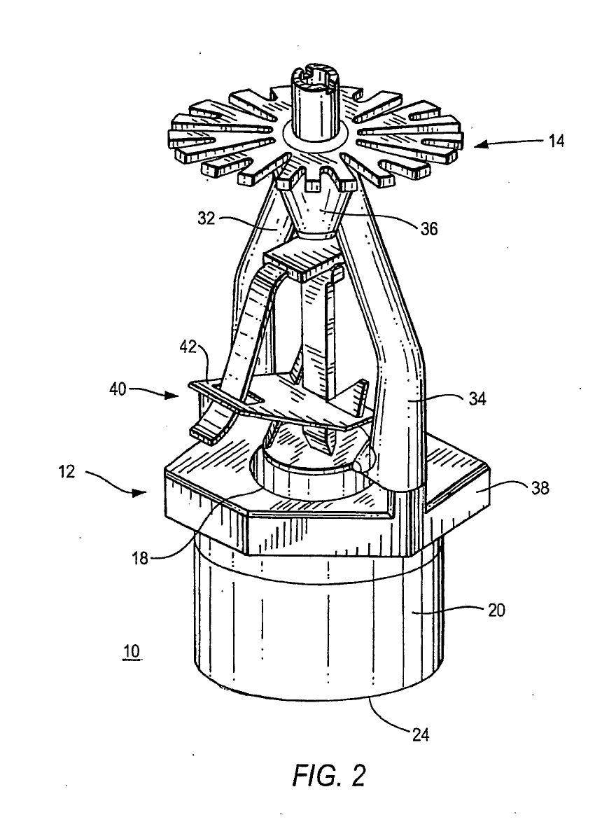

Sprinkler 10 further includes an operating mechanism 40 for closing the internal passageway 22 at the outlet orifice 18 (shown in FIG. 2) to prevent the flow of water until a fire occurs. In one embodiment, a heat responsive trigger in the form of a frangible glass bulb 46 is mounted to releasably retain closure until the trigger is activated.

The bulb 46 is filled with a heat responsive liquid. During a fire, the ambient temperature rises, causing the liquid in the bulb 46 to expand. When the ambient temperature reaches the rated temperature of the sprinkler 10, the bulb 46 shatters. As a result, the passageway 22 is cleared of all sealing parts and water is discharged towards the deflector 14. Although a frangible bulb is illustrated, other triggering devices as are well known in the art are also suitable.

For example, as illustrated in FIG. 2, the operating mechanism 40 can be in the form of a fusible solder link 42. When the ambient temperature from a fire reaches the rated temperature of the sprinkler 10, the solder softens and the link separates, thereby releasing the sealing parts that close the outlet orifice 18. As a result, the passageway 22 is cleared of all the sealing parts and water is discharged towards the deflector 14.

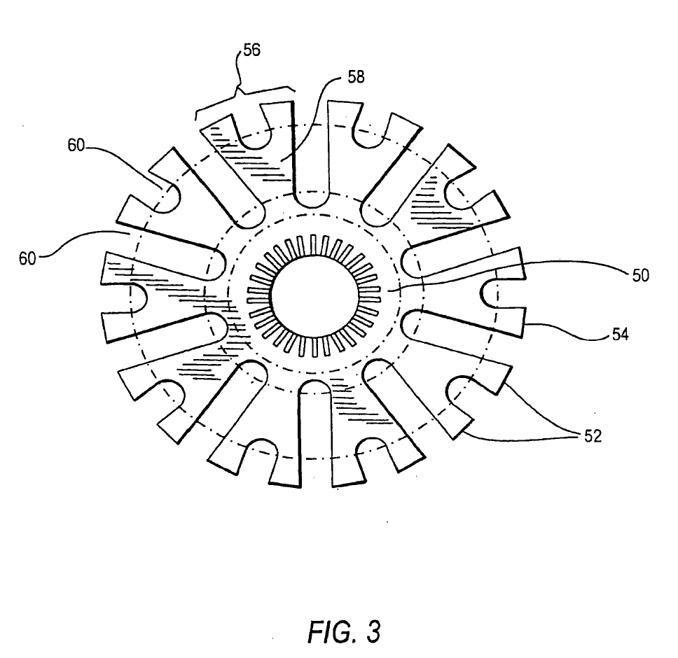

The deflector 14 shown in detail in FIG. 3 is preferably used with pendent sprinklers. The deflector is one illustrative embodiment and others will become apparent to those skilled in the art, without undue experimentation given the objective of having a sprinkler which will provide, upon actuation, a pathway for water to be directed somewhat centrally below the sprinkler and, as well, radially outward so that the effective radially outward area of coverage will preferably be in excess of 100 square feet, preferably less than 200 square feet, and preferably in the order of 144 square feet. Nonetheless, as will be understood by one skilled in the art, a lesser area of coverage, e.g., 80 square feet, may be desired for installations where a closer arrangement (i.e., positioning) of sprinklers is required.

As shown in FIGS. 1 and 2, the deflector 14 has a generally planar annular central section 50 having a generally circular periphery 36. A plurality of tines 52 each extend radially outwardly to a respective outer edge 54. The tines 52 are spaced circumferentially.

As shown in FIG. 3, each pair of tines define a somewhat Y shaped unit 56 with the embodiment in FIG. 3 having 10 such Y shaped units 56 in the array.

The solid surfaces 58 of each Y shaped unit 56 direct the flow of water outward. The slots or open areas 60 providing pathways for water to be directed more immediately downward. In its preferred embodiment the slots which permit the flow more directly beneath the deflector are less open than, for example, a comparable deflector for a comparably sized suppression sprinkler. As a result, a greater proportion of the water is directed radially outward and to a degree, the amount of water channeled directly beneath the sprinkler head is reduced.

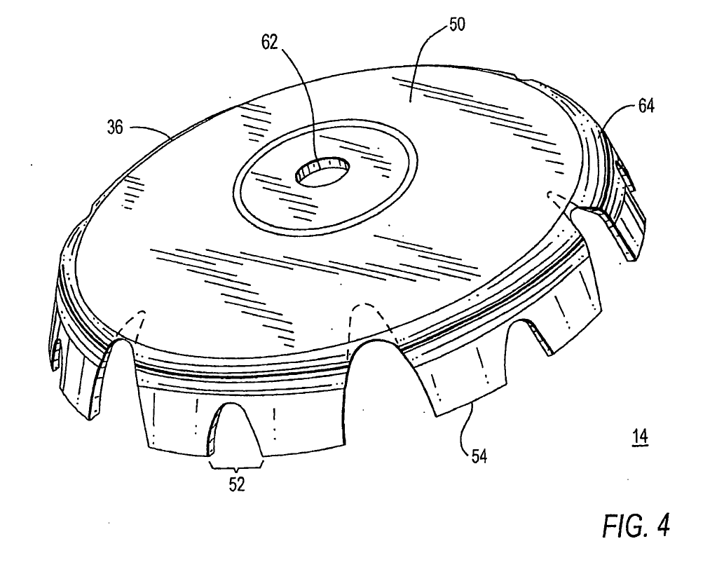

FIG. 4 illustrates an embodiment of a deflector 14 that is preferably used with an upright sprinkler, the body of the sprinkler generally being as disclosed hereinabove for a pendant sprinkler. The deflector 14 includes a generally solid annular central section 50 having a generally circular periphery 36. An aperture 62 is provided in the center of the central section 50 for attachment to the frame 12 in a conventional manner. Preferably, the central section 50 is somewhat concave from the perspective of the outlet orifice 18 when the pendent 14 is attached to the frame 12.

An annular flange 64 is integrally formed at the periphery 36 of the central section 50. The annular flange 64 is curved or slanted in a direction somewhat normal to the central section 50. The annular flange 64 includes a plurality of slots 60 which form a plurality of spaced-apart tines 52 that extend radially outwardly to a respective outer edge 54.

The solid surfaces of the central section 50 and the plurality of tines 58 direct the flow of water downward. That is, when the upright sprinkler is activated, water flows from the outlet orifice 18 and is deflected downward by the concave shaped central section 50 and downward slanting tines 52 of the deflector 14. Conversely, the slots or open areas 60 provide pathways for water to be directed more immediately upward and outward. In its preferred embodiment, the slots which permit the flow radially outward from the deflector are more open than, for example, a comparable deflector for a comparably sized sprinkler. Moreover, the slots 60 formed in the annular flange 64 can also extend a distance into the central section 50 (as drawn in phantom of FIG. 4) and/or additional slots 60 (not shown) can be formed in the central section. As a result, a greater proportion of the water is directed radially outward and to a degree, the amount of water channeled directly beneath the sprinkler head is reduced.

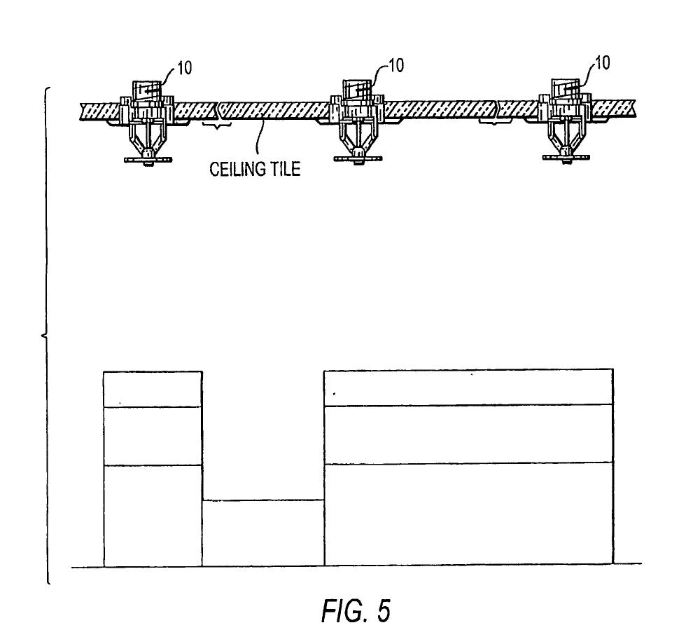

FIG. 5 schematically illustrates a sprinkler system incorporating a plurality of the individual sprinklers 10, each spaced apart by a distance of, for example, 10 to 12 feet.

The spacing is such that, given the RTI and dispersion characteristics of the sprinkler 10, a plume that will activate a single sprinkler will, at the same time, actuate at least one additional and preferably an array of 4 to 10 sprinklers at substantially the same time, and thereby provide a combined actual delivered density (ADD) to penetrate the plume, cool the ceiling, pre wet adjacent areas, and more likely, directly attack the area of actual conflagration in high ceiling extra hazard and high piled storage occupancies. As well, the sprinklers are capable of use at water pressures sufficiently low as generally not to require supplemental pumps.

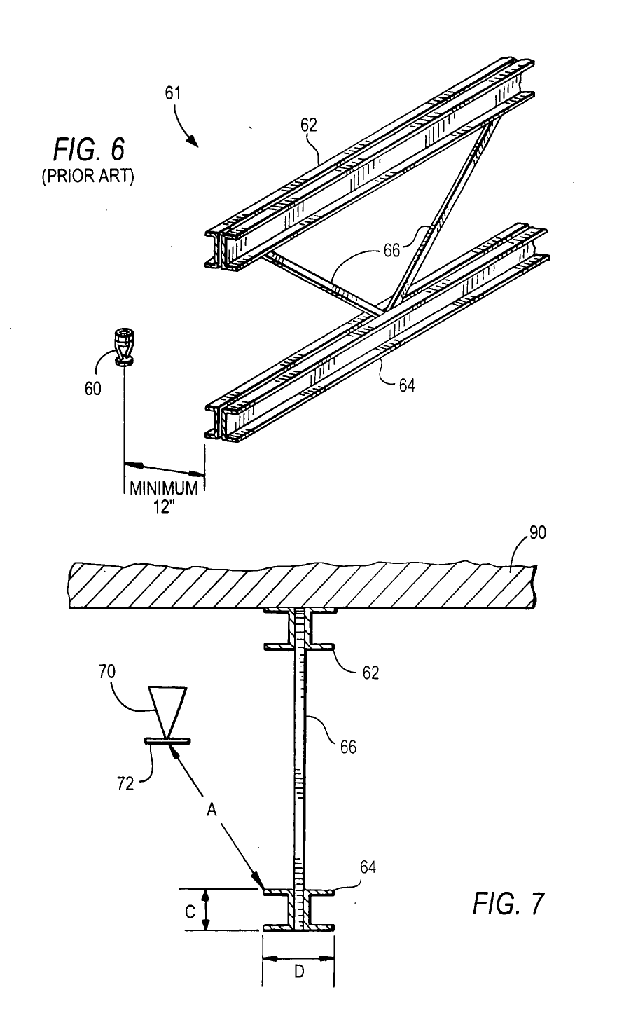

FIG. 6 depicts a prior art ESFR K-25 sprinkler 60 spaced from structural members 61 such as those typically encountered in a high ceiling compartment, warehouse or other indoor storage area and indicating the minimum spacing (12″) required under NFPA-13 standards. The structural members 61 can be open-webbed beams that extend across and support the ceiling of the compartment or indoor storage facility. In one embodiment, the structural members 61 are open-web trusses having an upper support flange 62, a lower support flange 64, and a plurality of cross support members 66 spaced apart and fixedly extending between the upper and lower support flanges.

FIG. 7 illustrates a sprinkler head 70 of the present invention, which due to the lower pressure created by the activation of multiple sprinklers, either simultaneously or through rapid sequencing, can be spaced above and laterally spaced from the structural members, which can be an open web steel truss such as shown in FIG. 6 or a wood truss such as is often encountered in warehouse or other storage environments.

It has been found that if the distance (A) measured from the center of the deflector 72 is greater than 3 times the height of the obstruction or 3 times the width of the obstruction, (i.e., the closest edge or surface point of the structural member) and the K factor is 25 or above and the pressure is 50 psi or less, and the ceiling height is 25 feet or greater, that the drop sizes will be sufficiently large even after encountering the structural members such that sufficient ADD is maintained to penetrate the fire plume and satisfy NFPA-13 requirements for a control mode sprinkler.

For example, as shown in FIG. 7, the upper support flange 62 of the structural member (e.g., truss) 61 is positioned directly below the ceiling 90 of the indoor storage (e.g., warehouse storage). The lower support flange 64 is connected to the upper support flange 62 by the vertically extending cross members 66. The sprinkler 70 is positioned laterally above the lower support flange 64 and fastened (e.g., threaded) to the fire extinguishing liquid drop or supply pipe (not shown).

In this illustrative embodiment, the lower support flange 64 is a portion of the truss that would be considered an obstructing structural member with respect to the sprinkler 70 of the present invention, since the lower support flange 64 is positioned laterally of and below the fire extinguishing liquid dispersion pattern of the sprinkler 70. The obstructing lower support member 64 has a height “C” and a width “D”, as shown in the elevational view of the truss in FIG. 7.

In accordance with the present invention, since the CMSA sprinkler 70 is positioned laterally of and above the obstructing member at a radial distance greater than at least three times a largest dimensional value of either the height or width of the obstructing member (e.g., lower support member 64, where A>3C or 3D), the droplets of the fire extinguishing liquid dispersed from the sprinkler will be sufficiently large in accordance with the requirements under NFPA-13, even after encountering the obstructing lower support flange 64. Although the structural member 61 is described and shown as a truss having a lower flange member 64 that obstructs the dispersion pattern of the fire extinguishing liquid, a person of ordinary skill in the art for which the invention pertains will appreciate that the present invention is applicable to other structural members (e.g., I-beams) installed in the indoor storage area that are positioned below the sprinkler 70, as well as that the entire structural member can be considered an obstructing member.

Further, although the present invention is described as a single CMSA sprinkler being installed in a compartment or indoor storage area (e.g., warehouse), a person of ordinary skill in the art for which the invention pertains will appreciate that the present invention is applicable to an array of sprinklers being installed in the compartment or warehouse. Specifically, each sprinkler in the array that has an obstructing structure within the dispersion pattern of the fire extinguishing liquid is positioned laterally of and above the obstructing member at a radial distance greater than at least three times a largest dimensional value of either the height or width of the obstructing member (e.g., lower support member 64), such that the droplets of the fire extinguishing liquid dispersed from the sprinkler will be sufficiently large in accordance with the requirements under NFPA-13, even after encountering the obstructing structure.

While the disclosed apparatus has been particularly shown and described with respect to the preferred embodiments, it is understood by those skilled in the art that various modifications in form and detail may be made therein without departing from the scope and spirit of the invention. Accordingly, modifications such as those suggested above, but not limited thereto are to be considered within the scope of the invention, which is to be determined by reference to the appended claims.

What is claimed is:

1. A control mode low pressure, large drop sprinkler for use in protection of at least extra hazard and high piled storage occupancies and adapted to be arrayed such that the coverage of the sprinkler and like adjacent sprinklers are in a range of greater than 80 square feet and less than 200 square feet including a generally tubular body having an inlet end and an opposing end with an internal passageway there between;
a deflector coupled with the tubular body and spaced from and generally in line with the discharge end of the internal passageway so as to be impacted by the flow of water issuing from the discharge end of the passageway upon activation of the sprinkler;
a closure releasably positioned at the discharge end of the tubular body so as to close the internal passageway; and
a heat responsive trigger mounted to releasably retain the closure at the discharge end of the tubular body characterized in that:
the sprinkler has a K factor greater than 16 and less than 40; and
the deflector having a series of solid and open areas, with the solid areas being adapted upon release of water in the range of 7 psi-50 psi to disperse the flow of water outwardly such that it will, when descending from a ceiling height of 25 feet or greater, cover an area of greater than 80 square feet and less than 200 square feet when the water is located at a height with respect to a fire to control the same within at least the 1999 Edition guidelines of NFPA 13.

2. The sprinkler of claim 1, wherein the deflector is generally planar and the sprinkler is a pendent sprinkler.

3. The sprinkler of claim 1, wherein the sprinkler is an upright sprinkler.

4. The sprinkler of claim 1, wherein said sprinkler is adapted for installation below a ceiling of an indoor storage area having a structural member positioned below the ceiling, said structural member having at least one obstructing member portion having a height and width, said sprinkler being positioned laterally of and above said obstructing member portion at a radial distance greater than at least three times a largest dimensional value of either the height or width of said obstructing member, such that droplets of a fire extinguishing liquid dispersed from said sprinkler are sufficiently large in accordance with the requirements under NFPA-13, even after encountering said obstructing member portion.

5. The sprinkler of claim 4, wherein said radial distance is measured from a center of the deflector to a closest surface point of said obstructing member portion.

6. The sprinkler of claim 4, wherein said structural member is an open-web truss and said obstructing member portion is a lower support flange.

7. The sprinkler of claim 4, wherein said indoor storage area is a warehouse storage area.

8. The sprinkler of claim 4, wherein said indoor storage area is a compartment.

9. The sprinkler of claim 4, wherein droplets of a fire extinguishing liquid dispersed from said sprinkler are sufficiently large to penetrate a fire plume at a density which satisfies the requirements under Factory Mutual Global Datasheets, even after encountering said obstructing member portion.

10. An array of at least two low pressure, large drop sprinklers for use in protection of at least extra hazard and high piled storage occupancies and adapted to be arrayed such that the coverage of each sprinkler is in a range of greater than 80 square feet and less than 200 square feet wherein each sprinkler includes a generally tubular body having an inlet end and an opposing end with an internal passageway there between;
a deflector coupled with the tubular body and spaced from and generally in line with the discharge end of the internal passageway so as to be impacted by the flow of water issuing from the discharge end of the passageway upon activation of the sprinkler;
a closure releasably positioned at the discharge end of the tubular body so as to close the internal passageway; and
a heat responsive trigger mounted to releasably retain the closure at the discharge end of the tubular body characterized in that:
the sprinkler has a K factor greater than 16 and less than 40; and
the deflector having a series of solid and open areas, with the solid areas being adapted upon release of water in the range of 7 psi-50 psi to disperse the flow of water outwardly such that it will, when descending from a ceiling height of 25 feet or greater, cover an area of greater than 80 square feet and less than 200 square feet when the water is located at a height with respect to a fire to control the same within at least the 1999 Edition guidelines of NFPA 13, and whereas the sprinklers are spaced apart a distance such that sufficient heat to actuate the trigger of one sprinkler will actuate the trigger on at least one adjacent sprinkler.

11. The array of sprinklers of claim 10, wherein each sprinkler is a pendent sprinkler.

12. The array of sprinklers of claim 10, wherein each sprinkler is an upright sprinkler.

13. The array of sprinklers of claim 10, wherein the release of water for each sprinkler is in the 7 psi-10 psi range.

14. The array of sprinklers of claim 10, wherein each said sprinkler is adapted for installation below a ceiling of an indoor storage facility having a structural member positioned proximately below the ceiling, said structural member including at least one obstructing member portion having a height and width, said sprinkler being positioned laterally of and above said obstructing member portion at a radial distance greater than at least three times a largest dimensional value of either the height or width of said structural member, such that droplets of a fire extinguishing liquid dispersed from said sprinkler are sufficiently large in accordance with the requirements under NFPA-13, even after encountering said obstructing member portion.

15. The sprinkler of claim 10, wherein said radial distance is measured from a center of the deflector to a closest surface point of said obstructing member portion.

16. The sprinkler of claim 10, wherein said structural member is an open-web truss and said obstructing member portion is a lower support flange.

17. The sprinkler of claim 10, wherein said indoor storage area is a warehouse storage area.

18. The sprinkler of claim 10, wherein droplets of a fire extinguishing liquid dispersed from said sprinkler are sufficiently large in accordance with the requirements under Factory Mutual Global Datasheets, even after encountering said obstructing member portion.
